(19) United States
(12) Patent Application Publication
(10) Pub. No.: US 2009/0063265 A1
(43) Pub. Date: Mar. 5, 2009

(54) INFORMATION NETWORK FOR TEXT ADS

(75) Inventor: Jagadeshwar R. Nomula, Sunnyvale, CA (US)

Correspondence Address: BRINKS HOFER GILSON & LIONE / YAHOO! OVERTURE, P.O. BOX 10395, CHICAGO, IL, 60610, US

(73) Assignee: Yahoo! INC., Sunnyvale, CA (US)

(21) Appl. No.: 11/849,772

(22) Filed: Sep. 4, 2007

(51) Int. Cl. G06Q 30/00

(52) U.S. Cl. 705/14

(57) ABSTRACT

In an information network for text ads, a method includes receiving a subscriber web page from a text ad subscriber and choosing a plurality of internet websites to display hyperlinks thereof on the subscriber webpage by: analyzing the subscriber webpage with a keyword extractor, wherein the keyword extractor parses and tokenizes the text on the subscriber web page to determine a top at least two keywords of those analyzed based on a popularity and a token frequency of the keywords; querying a search engine and a social bookmarks server with the at least two keywords to provide resultant websites with a ranking score; selecting a top predetermined number of websites from a union of website results from the search engine and social bookmark queries based on their respective ranking scores; randomly choosing the plurality of internet websites from among the top predetermined number of websites; and displaying hyperlinks to the plurality of chosen internet websites on the subscriber webpage.

### BACKGROUND

1. Technical Field

The disclosed embodiments relate to an information network for text advertisements (ads), and more specifically, to a system and method for adding hyperlinks and text ads of web pages that are co-relevant to the web pages on which they are being displayed.

2. Related Art

The current platform for textual advertisements (text ads) spread around the World Wide Web (WWW) and the internet in general to large extent ignores the publisher-publisher closeness in displaying ads as well as the relevancy of the larger body of web sites that are published. For instance, various text ads are added to web sites based on advertisers or publishers paying for the ad placement on those web sites. The text ads, therefore, may be targeting consumers most likely to traffic such web sites, but are not necessarily advertising or linking to other web sites that are the most relevant to the web pages on which they are displayed.

### SUMMARY

By way of introduction, the embodiments described below are drawn to an information network for text advertisements (ads), and more specifically, to a system and method for adding hyperlinks and text ads of web pages that are co-relevant to the web pages on which they are being displayed.

In a first aspect, a method is disclosed for forming an information network of text advertisements (ads) and informational copy on the internet, including receiving a subscriber web page from a text ad subscriber over a network; and choosing a plurality of internet websites to display hyperlinks thereof together with any currently displayed text ads on the subscriber web page by: analyzing the subscriber web page with a keyword extractor, wherein the keyword extractor parses and tokenizes the text on the subscriber web page while ignoring common stop words to determine a top at least two keywords of those analyzed based on a popularity of the keywords and a token frequency of occurrence of the keywords; querying a search engine and a social bookmarks server with the top listed at least two keywords to provide resultant websites with a ranking score; selecting a top predetermined number of websites from a union of website results from the search engine query with those of the social bookmark query based on their respective ranking scores; randomly choosing the plurality of internet websites from among the top predetermined number of websites; and displaying hyperlinks to the plurality of chosen internet websites on the subscriber web page.

In a second aspect, a method is disclosed for forming an information network of text ads and informational copy on the internet, including receiving at least one subscriber web page from a text ad subscriber over a network; pulling a plurality of non-subscriber web pages from the internet; and choosing a plurality of internet websites to display hyperlinks thereof on each of the at least one subscriber web page and the plurality of non-subscriber web pages (“plurality of web pages”) by: analyzing each of the plurality of web pages with a keyword extractor, wherein the keyword extractor parses and tokenizes the text on each web page while ignoring common stop words to determine a top at least two keywords of those analyzed based on a popularity of the keywords and a token frequency of occurrence of the keywords; querying, in parallel, both a search engine and a social bookmarks server with the top listed at least two keywords to provide resultant websites with a ranking score; selecting a top N websites from a union of web page results from the search engine query with those of the social bookmark query based on their respective ranking scores; randomly choosing the plurality of internet websites from among the top N web pages; and displaying hyperlinks to the plurality of chosen internet websites on respective each of the plurality of web pages.

In a third aspect, a system is disclosed for forming an information network of text ads and informational copy, including a communicator to receive a subscriber web page from a text ad subscriber over an internet. A crawler pulls web pages from other publishers over the internet. A keyword extractor, for each web page received or pulled, extracts at least two of the top listed keywords by parsing and tokenizing the text on the web page while ignoring common stop words, and by analyzing a popularity and a token frequency of occurrence of the extracted words. A processor is in communication with the communicator and the keyword extractor to query a search engine and a social bookmarks server with the top listed at least two keywords of each web page to provide resultant websites with a ranking score. The processor selects a top predetermined number of website results from a union of the search engine and social bookmarks server queries based on their respective ranking scores, and then randomly chooses a plurality of internet websites from among the top N web pages. The communicator uploads hyperlinks to the plurality of randomly chosen websites to the corresponding analyzed web page for display thereon.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a system diagram of an information network for text ads employing a publisher match server having a keyword extractor and a crawler, and thus functioning as a meta-search engine for finding websites co-relevant with web pages and for adding hyperlinks of the websites to the co-relevant web pages.

FIG. 2 is a flow chart of a method for establishing an information network in which hyperlinks and related text ads or informational snippets of websites are displayed on co-relevant web pages, and in which the click traffic from the displayed hyperlinks are tracked.

### DETAILED DESCRIPTION

In the following description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

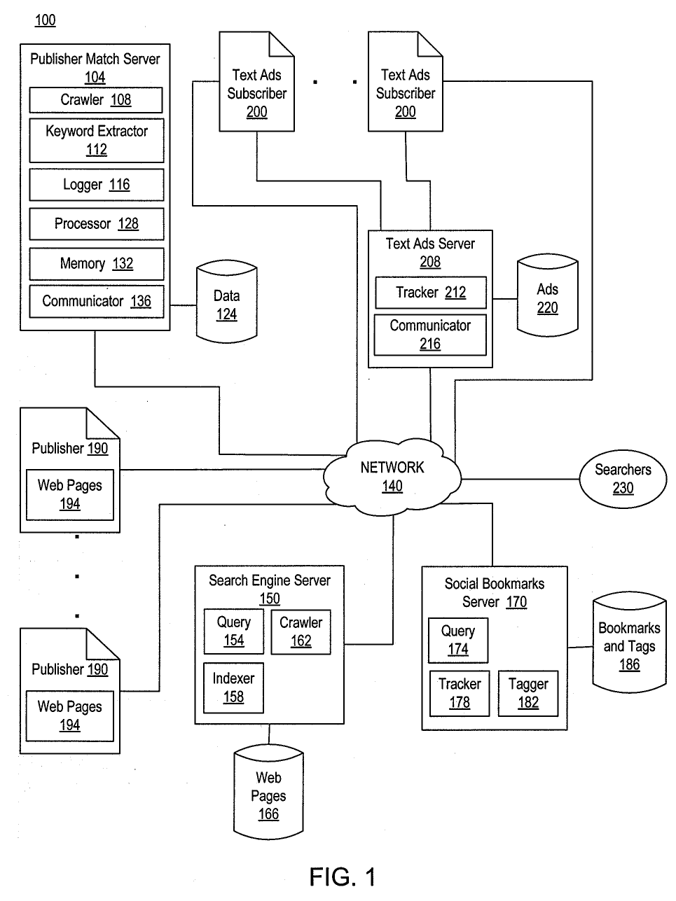

FIG. 1 is a system diagram of an information network 100 for text ads employing a publisher match server 104. The publisher match server 104 includes a crawler 108, a keyword extractor 112, a logger 116, a database 124, a processor 128, a memory 132, and a communicator 136, which communicates over a network 140 with the rest of the information network 100. The network 140 may include a local area network (LAN), a wide area network (WAN), the internet and/or other types of networks. The information network 100 further includes a search engine having a search engine server 150 that includes a query module 154, an indexer 158, a crawler 162, and a web pages database 166 and other modules as are known in the art. The search engine server 150 also communicates over the network 140.

The information network 100 also includes a social bookmarks server 170 having a query module 174, a bookmark tracker 178, a tagger 182, and a database 186 for bookmarks and tags. A plurality of publishers 190 publish their respective web pages 194 to the internet through the network 140. A plurality of text ads subscribers 200 communicate over the network 140 and with a text ads server 208. The text ads server 208 includes at least a tracker 212, a communicator 216, and an ads database 220. A plurality of searchers 230 (variably referred to as “users”) browse the internet web pages, which include those published by the publishers 194 and those submitted by the text ads subscribers 200.

The social bookmarks server 170 includes a query module 174 that allows submission of key word searches, similar to that of the search engine 150, to search through a database 186 of bookmarks and tags. The query module 174 is accessible through a website (such as del.icio.us.com, digg.com, or BlogMarks.net, etc.) that makes the database 186 available and allows individual users to collect their favorite web page bookmarks that link to blogs, articles, music, videos, reviews, recipes, or other types of information on the internet. Such websites also generally allow the users to share these favorites with others, thus the term “social book-marking.” The stored bookmarks are then accessible from anywhere a user has an internet connection by the server 170 tracking with the tracker 178 the various bookmarked websites for each participating user. The tagger 182 allows users to tag the bookmarks with a descriptive term or phrase in way that helps the user to remember the bookmark. Favorite or interesting links may also be shared among users. This creates a database 178 rich in both bookmarks and related tags that not only indicate relevance to topics searched for, but also popularity thereof as gauged by the general population that uses the social book-marking.

The text ads server 208 interacts with the text ads subscribers 200 that pay for text ads related to their businesses on the web pages 194 of the publishers 190. Note that the publishers 190 may also be text ads subscribers 200. Therefore, the publishers 190 and text ads subscribers 200 are individually labeled in FIG. 1 to indicate a role being played by any party or online business. Many publishers 194 post web pages 194 of online businesses that seek to advertiser those businesses, and therefore, also subscribe for the addition of text ads to other web sites. These various text ads, stored in database 220, are tracked by the tracker 212 to determine how many times searchers 230 click through hyperlinks associated with the text ads. This tracking in turn allows the texts ads server 208 (or other text ads subscriber manager) to track various success metrics such as click-through rate (CTR) and return on investment (ROI). As discussed, however, because these are previously paid-for ads, the text ads are displayed on web pages 194 that are usually browsed to by a target market related to the text ads. Accordingly, the text ads are often not related to the subject matter of the web pages 194 in which they are displayed, being more of a commercial nature, not an informational one.

The present disclosure seeks to augment the current text ads on web pages 194 by creating an automated system that forms an information network 100 in which hyperlinks (and optionally information copy therewith) of web pages are displayed on other web pages 194 that are co-relevant therewith. That is, a hyperlink and ad/informational copy for a web site A may be displayed, for instance, near the currently present text ads on a web site B, such that web sites A and B are co-relevant. Co-relevance means that they share in common or similar subject matter. For example, a hyperlink to a Latino-related online music store (web site B) is added to an article on CNN.com about the newest rising star in the Latino music industry.

The crawler 108 of the publisher match server 104 can act similar to that of the search engine server 150, and continuously look for web pages 194 from which to glean keywords. Additionally, the text ads server 208 also submits web pages for analysis to the publisher mach server 104 by text ads subscribers 100 who specifically request to be a part of the information network 100. The crawler 108 works in conjunction with various modules of the publisher match server 104, such as the keyword extractor 112, which parses and tokenizes the text on an internet web page while ignoring common stop words such as “and” and “the.” The keyword extractor 112 then extracts a few to a handful of keywords of those analyzed based on both a popularity of the keywords and a token frequency of occurrence of the keywords. The popularity and token frequency of the analyzed keywords can be determined from the logger 116 or a different tracker module (not shown) of the match server 104 that tracks keyword usage over the internet, e.g. the number of times a keyword is searched on over a last predetermined period of time. A weight may also be allocated to the token frequency (e.g., 50%) and to the popularity (e.g., 50%).

Once a plurality of keywords are extracted from the internet web page, the publisher match server 104 searches for relevant websites for web page display of hyperlinks thereof. In addition, and optionally, a text ad or informational copy may accompany one or more of the hyperlinks. Searching for other websites with relevant information is accomplished by running at least two parallel searches on the plurality of extracted keywords. One of the parallel searches may include, for instance, queries of search engines 150 such as Yahoo!®, Google®, Excite®, etc. The search engine 150 may also include Y!Q Search, or other engines that provide the top most related websites based on a document. Another parallel search may include, for instance, a query of a social book-marking site such as del.icio.us.com as discussed above. A query of the social bookmarks server 170 includes a text search through both bookmarks themselves and tags associated therewith. As discussed above, use of a social book-marking site helps to narrow a union set of results searched for by the publisher match server 104 to those most relevant and those that are most popular.

The top website results from the search engine 150 query and the top website results of the social bookmark server 170 query are combined as a union set, thus eliminating redundancy in the union set of search results, and a predetermined number (N) of top websites in the union set of results is returned. This predetermined number N, for instance, may be the top 25 websites. A random plurality of the top predetermined number of N of the union set of search results is chosen for subsequent hyperlink display on the webpage that resulted the plurality of keywords for which the relevant websites were searched.

In conducting the query through a search engine 150 with the plurality of keywords, combinations of the plurality of keywords are employed in various search strategies. A top M number of web pages that result from each combination search are recorded in memory 132 and/or the database 124. A union is taken of each of the top M websites that resulted from the combination searches, wherein the union is a first union set of search results. The first union set of results for co-relevance is analyzed with reference to the content of the web page. A rank score is given to each website of the first union set of results based on a cosine similarity between the first union set of results and the content of the subscriber web page. Each score is then normalized to a scale of 100.

In conducting the query through a social bookmarks server 170 with the plurality of keywords, combinations of the plurality of keywords are employed in various search strategies. A top M number of web pages that result from each combination search are recorded in memory 132 and/or the database 124. A union is taken of each of the top M websites that resulted from the combination searches, wherein the union is a second union set of search results. The second union set of results for co-relevance is analyzed with reference to the content of the web page. A rank score is given to each website of the second union set of results based on a cosine similarity between the second union set of results and the content of the subscriber web page. Each score is then normalized to a scale of 100.

In each of the searches referenced above, whether through a search engine 150 or a social bookmarks server 170, the score for a website is doubled when it is found in both the first and second sets of results. The maximum score, therefore, of the finally returned set of top scored websites is 200. As discussed before, a predetermined number N of top websites in the union set of results from the search engine 150 query and the social book mark server 170 query is obtained by the publisher match server 104. This step may include the requirement that each selected website in the top predetermined number N of websites have a ranking score above a minimum threshold, such as 80. Furthermore, the random selection of the plurality of websites for hyperlink display on keyword extracted web pages may include a probabilistic bias toward higher scored websites.

Note again that the web pages that are analyzed for keyword extraction include those submitted by text ads subscribers 200 in addition to the web pages 194 submitted by publishers 194 that are not also considered to be a text ads subscriber 200. For the purpose of tracking clicking activity on the displayed hyperlinks of the plurality of randomly chosen top websites, the logger 116 and/or the tracker 212 may log the clicks on the hyperlinks displayed on text ads subscriber 200 web pages. If clicks are tracked by the tracker 212 of the text ads server 208, this statistical data may be communicated back to the publisher match server 104 by the communicator 216.

Some of the clicked hyperlinks lead searchers 230 to target web pages for which revenue is paid to the text ads subscribers 200 that own the web pages containing the clicked hyperlinks, assuming that the text ads subscribers 200 are part of a “publisher network.” A publisher network is a group of text ads subscribers 200 that agree to share revenue based on directing traffic to target website from their text ad links. In some cases, a series or chain of text ads subscribers 200 web pages lead to the target websites, in which case the various text ad subscribers 200 share in revenue. The revenue may be shared with a lesser amount paid to subsequent clickers down the chain of clicked web pages. For instance, a web page of a text ad subscriber A contains a hyperlink that is clicked, leading a user to a web page of a text ad subscriber B. The web page of text ad subscriber B also contains a hyperlink that is clicked, ultimately leading the user to a target web page. In this case, the text ad subscriber A may receive two-thirds of the revenue while text ad subscriber B may receive the remaining one-third of available revenue for clicking activity to the target web page.

In some cases, a web page 194 owned by a publisher 190 that is not also a text ads subscriber 200 will be reached by virtue of clicking through hyperlinks displayed on web pages of the text ads subscriber 200. In such a case, the publisher 190 is considered “the target web page,” which publisher 190 may then be charged a predetermined charge for the directed traffic. The one or more text ads subscriber 200 that directed the traffic would collect the charge as revenue. Note that the revenue generation and charging may be tracked by either the publisher match server 104 or the text ads server 208, both of which communicate with each other across the network 140. That revenue is shared for some of the clicking activity within the publisher network is not critical, and does not preclude building a larger information network through hyperlink placement on publisher web pages 194.

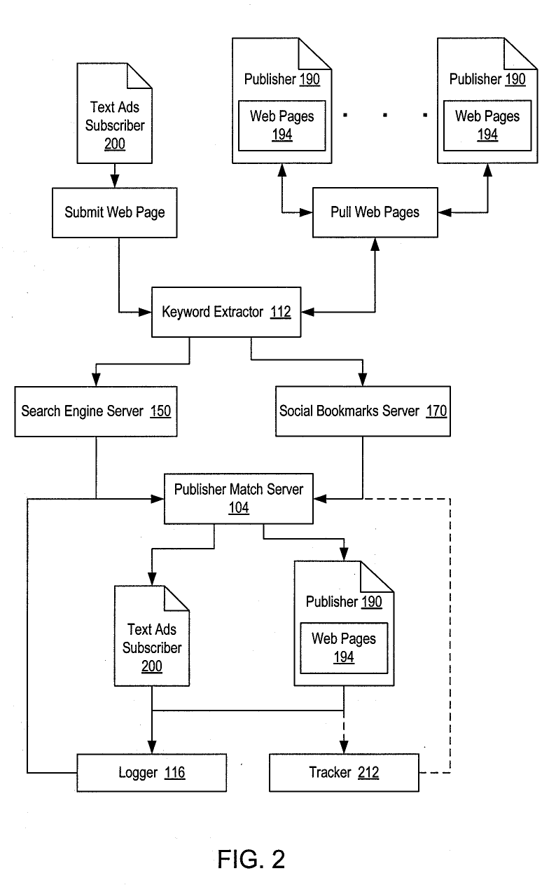

FIG. 2 is a flow chart of a method for establishing an information network 140 in which hyperlinks and related text ads or informational snippets of websites are displayed on co-relevant web pages, and in which the click traffic from the displayed hyperlinks are tracked. The text ads subscribers 200 submit web pages to the keyword extractor 112 while web pages 194 are pulled from other publishers 190 on the internet. As discussed above, the keyword extractor 112 extracts a plurality of keywords from each of the web pages it analyzes, which keywords may be as few as two. For each web page being analyzed, combinations of the keywords are then submitted to both the search engine server 150 and the social bookmarks server 170 to generate various sets of results. These various sets of search results for the combination queries are then sent to the publisher match server 104.

Within the publisher match server 104, the processor 128 takes a union of each of the top M websites that result from the combination searches for the search engine server 150 (the “first union set of results”). A union is also taken of each of the top M websites that result from the combination searches for the social bookmarks server 170 (the “second union set of results”). A rank score is given to each website of the first and second union sets of results based on a cosine similarity between respective first and second union sets of results and the content of the web page being analyzed. Each score is then normalized to a scale of 100. The processor 128 then takes a union of the top scored websites to eliminate redundancy, returning a top predetermined number N of the scored websites. The processor 128 then returns a random selection of a plurality of websites (e.g., 2-5 hyperlinks) from among the top scored websites for display on the analyzed web page. The displayed hyperlinks may be accompanied with a text ad or informational copy, and may be located near any other text ads already present on the web page, e.g. from paid placement through the text ads server 208.

The processor 128 or software running thereon may include the requirement that each selected website in the top predetermined number N of websites have a ranking score above a minimum threshold, such as 80 or 90. Furthermore, the random selection of the plurality of websites for hyperlink display on keyword extracted web pages may include a probabilistic bias toward higher scored websites.

Hyperlinks (and any text ad or informational copy) of the randomly selected plurality of websites are displayed on the web page that was analyzed to return such randomly selected plurality of websites from the publisher match server 104. This may be on a text ads subscriber 200 web page or on a web page 194 of a publisher 190. The logger 116 of the publisher match server 104 or the tracker 212 of the text ads server 208 can then track click activity on these hyperlinks so that the publisher match server 104 can accurately pay revenue to text ads subscribers 200 that direct traffic to target web pages as discussed previously.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A method for forming an information network of text advertisements (ads) and informational copy, comprising:
receiving a subscriber web page from a text ad subscriber over a network; and
choosing a plurality of internet websites to display hyperlinks thereof together with any currently displayed text ads on the subscriber web page by:
analyzing the subscriber web page with a keyword extractor, wherein the keyword extractor parses and tokenizes the text on the subscriber web page while ignoring common stop words to determine a top at least two keywords of those analyzed based on a popularity of the keywords and a token frequency of occurrence of the keywords;
querying a search engine and a social bookmarks server with the top listed at least two keywords to provide resultant websites with a ranking score;
selecting a top predetermined number (N) of websites from a union of website results from the search engine query with those of the social bookmark query based on their respective ranking scores;
randomly choosing the plurality of internet websites from among the top predetermined number of websites; and
displaying hyperlinks to the plurality of chosen internet websites on the subscriber web page.

2. The method of claim 1, wherein the popularity and the token frequency of the keywords are determined by a logger that tracks the frequency and context of the keywords that are searched for by users of the internet.

3. The method of claim 1, wherein displaying hyperlinks to the plurality of chosen internet websites includes displaying ad or informational copy of the results related to each hyperlink.

4. The method of claim 1, wherein querying the search engine comprises:
querying the search engine with the at least two keywords using different combinations thereof;
recording a top M number of websites that result from each combination search of the search engine;
taking a union of each of the top M number of websites that result from all of the combination searches to result a first union set of results;
analyzing the first union set of results for co-relevance with the content of the subscriber web page;
giving the ranking score to each website of the first union set of results based on a cosine similarity between the first union set of results and the content of the subscriber web page; and
normalizing each score on a scale of 100.

5. The method of claim 4, wherein querying the social bookmarks server comprises:
querying the social bookmarks server for bookmarks and tags that match any combination of the at least two keywords;
recording a top M number of websites that result from each combination search of the social book-marking query;
taking a union of each of the top M number of websites that result from all of the combination searches to result a second union set of results;
analyzing the second union set of results for co-relevance with the content of the subscriber web page;
giving the ranking score to each website of the second union set of results based on a cosine similarity between the second union set of results and the content of the subscriber web page; and
normalizing each score on a scale of 100.

6. The method of claim 5, wherein the score for a website result is doubled when found in both the first and second union sets of results.

7. The method of claim 1, wherein selecting at least a top predetermined number of websites comprises requiring that each selected website in the top predetermined number of websites have a ranking score above a minimum threshold.

8. The method of claim 1, wherein the random selection of the plurality of websites for hyperlink display on the subscriber web page comprises a probabilistic bias towards higher scored websites.

9. The method of claim 1, further comprising:
pulling a plurality of web pages from the internet to be analyzed;
for each of at least some of the pulled plurality of web pages, selecting a plurality of internet websites that are co-relevant with content of each of the at least some of the plurality of web pages; and
displaying the hyperlinks corresponding to the plurality of internet websites on each of the at least some of the pulled plurality of web pages.

10. The method of claim 9, wherein receiving a subscriber web page comprises receiving a plurality of subscriber web pages from multiple text ad subscribers, and wherein choosing a plurality of internet websites to display hyperlinks thereof on the subscriber web page comprises choosing a plurality of co-related internet websites to display hyperlinks thereof on each of the plurality of subscriber web pages, the method further comprising:
logging a number of clicks on the plurality of hyperlinks that are displayed on the plurality of subscriber web pages; and
sharing revenue among the multiple text ad subscribers based on searchers reaching a plurality of target web pages by clicking on the hyperlinks displayed on the plurality of subscriber web pages.

11. The method of claim 10, wherein if the target web page reached is among the plurality of pulled web pages, the method further comprising:
charging an owner of the target web page for the directed traffic arising from at least one of the plurality of hyperlinks clicked on from one of the plurality of subscriber web pages.

12. A method for forming an information network of text advertisements (ads) or informational copy, comprising:
receiving at least one subscriber web page from a text ad subscriber over a network;
pulling a plurality of non-subscriber web pages from the internet; and
choosing a plurality of internet websites to display hyperlinks thereof on each of the at least one subscriber web page and the plurality of non-subscriber web pages (“plurality of web pages”) by:
analyzing each of the plurality of web pages with a keyword extractor, wherein the keyword extractor parses and tokenizes the text on each web page while ignoring common stop words to determine a top at least two keywords of those analyzed based on a popularity of the keywords and a token frequency of occurrence of the keywords;
querying, in parallel, both a search engine and a social bookmarks server with the top listed at least two keywords to provide resultant websites with a ranking score;
selecting a top N websites from a union of web page results from the search engine query with those of the social bookmark query based on their respective ranking scores;
randomly choosing the plurality of internet websites from among the top N web pages; and
displaying hyperlinks to the plurality of chosen internet websites on respective each of the plurality of web pages.

13. The method of claim 12, further comprising:
logging a number of clicks on the plurality of hyperlinks that are displayed on the plurality of web pages; and
sharing revenue among the multiple text ad subscribers based on searchers reaching a plurality of target web pages by clicking on the hyperlinks displayed on at least two subscriber web pages.

14. The method of claim 13, wherein if a target web page reached is among the plurality of non-subscriber web pages, the method further comprising:
charging an owner of the target web page for the directed traffic arising from at least one of the plurality of hyperlinks clicked on from one of the plurality of subscriber web pages.

15. The method of claim 12, wherein the popularity and the token frequency of the keywords are determined by a logger that tracks the frequency and context of the keywords that are searched for by users of the internet.

16. The method of claim 12, wherein displaying hyperlinks to the plurality of chosen internet websites includes displaying ad or informational copy of the website corresponding to each respective hyperlink.

17. The method of claim 12, wherein querying the search engine search comprises:
querying the search engine with the at least two keywords using different combinations thereof;
recording a top M websites result from each combination search of the search engine;
taking a union of each of the top M websites results of all of the combination searches to result a first union set of results.
analyzing the first union set of results for co-relevance with the content of the subscriber web page;
giving the ranking score to each website of the first union set of results based on a cosine similarity between the first union set of results and the content of the subscriber web page; and
normalizing each score on a scale of 100.

18. The method of claim 17, wherein using the top listed at least two keywords, in parallel, in a social bookmark query comprises:
querying a social bookmarks server for bookmarks and tags that match any combination of the at least two keywords;
recording a top M websites result from each combination search of the social book-marking query;
taking a union of each of the top M websites results of all of the combination searches to result a second union set of results.
analyzing the second union set of results for co-relevance with the content of the subscriber web page;
giving the ranking score to each website of the second union set of results based on a cosine similarity between the second union set of results and the content of the subscriber web page; and
normalizing each score on a scale of 100.

19. The method of claim 12, wherein selecting the at least top N websites comprises requiring that each selected website in the top N have a ranking score above a minimum threshold, and wherein the random selection of a plurality of websites for hyperlink display on the subscriber web page comprises a probabilistic bias towards higher scored websites.

20. A system for forming an information network of text advertisements (ads) and informational copy, comprising:
a communicator to receive a subscriber web page from a text ad subscriber over an internet;
a crawler to pull web pages from other publishers over the internet;
a keyword extractor to, for each web page received or pulled, extract at least two of the top listed keywords by parsing and tokenizing the text on the web page while ignoring common stop words, and by analyzing a popularity and a token frequency of occurrence of the extracted words;
a processor in communication with the communicator and the keyword extractor to query a search engine and a social bookmarks server with the top listed at least two keywords of each web page to provide resultant websites with a ranking score;
wherein the processor selects a top predetermined number (N) of website results from a union of the search engine and social bookmarks server queries based on their respective ranking scores, and then randomly chooses a plurality of internet websites from among the top N web pages; and
wherein the communicator uploads hyperlinks to the plurality of randomly chosen websites to the corresponding analyzed web page for display thereon.

21. The system of claim 20, wherein the communicator receives multiple subscriber web pages from a plurality of text ads subscribers, the system further comprising:
a logger in communication with the communicator to track a number of clicks of the displayed hyperlinks on each web page, and to track the frequency and context of the keywords that are searched for by searchers of the internet.

22. The system of claim 21, wherein the popularity and the token frequency of the keywords are determined by the logger.

23. The system of claim 21, wherein the communicator communicates with a text ads server to share revenue among the plurality of text ad subscribers of a publisher network based on searchers reaching a plurality of target web pages by clicking on the hyperlinks displayed on at least two of the subscriber web pages.

24. The system of claim 20, wherein the processor:
queries the search engine with the at least two keywords using different combinations thereof;
records a top M websites result from each combination search of the search engine;
takes a union of each of the top M websites results of all of the combination searches to result a first union set of results.
analyzes the first union set of results for co-relevance with the content of the subscriber web page;
gives the ranking score to each website of the first union set of results based on a cosine similarity between the first union set of results and the content of the subscriber web page; and
normalizes each score on a scale of 100.

25. The system of claim 20, wherein the processor:
queries a social bookmarks server for bookmarks and tags that match any combination of the at least two keywords;
records a top M websites result from each combination search of the social book-marking query;
takes a union of each of the top M websites results of all of the combination searches to result a second union set of results.
analyzes the second union set of results for co-relevance with the content of the subscriber web page;
gives the ranking score to each website of the second union set of results based on a cosine similarity between the second union set of results and the content of the subscriber web page; and
normalizes each score on a scale of 100.
